(19) United States
(12) Patent Application Publication
(10) Pub. No.: US 2020/0126099 A1
(43) Pub. Date: Apr. 23, 2020

(54) SYSTEM FOR PREDICTING TIME TO PURCHASE USING MODIFIED SURVIVAL ANALYSIS AND METHOD FOR PERFORMING THE SAME

(71) Applicant: AFFINITY SOLUTIONS INCORPORATED, NEW YORK, NY (US)

(72) Inventors: PING DENG, NEW YORK, NY (US); AKHILA NAGULA, NEW YORK, NY (US); NIPUN PALEKAR, NEW YORK, NY (US)

(21) Appl. No.: 16/165,826

(22) Filed: Oct. 19, 2018

(51) Int. Cl. G06Q 30/02

(52) U.S. Cl. CPC G06Q 30/0202

(57) ABSTRACT

In a method for estimating probability of purchase, a dataset of financial transactions is received. Values are determined for variables for each of the individuals of the dataset. An average time between purchases of a particular category is determined based on the dataset. The determined average time is correlated with the determined values. A table or function is produced for estimating probabilities of purchase within windows of time of the particular category based on the correlation. A subject is identified. Values are determined for the variables for the subject, based on the dataset. The produced table or function and the determined values are used to estimate a probability of purchase within the windows of time for the particular category for the subject.

### TECHNICAL FIELD

The present disclosure relates to predicting consumer purchasing behavior and, more specifically, to predicting consumer purchasing behavior using modified survival analysis and a system for making use of the predicted consumer purchasing behavior at point of sale.

### DISCUSSION OF THE RELATED ART

In the modern environment, brick-and-mortar retail establishments are facing significant competitive challenges from online retailers. Online retailers are able to effectively leverage information about individual shoppers to increase the likelihood of consummating sales. However, brick-and-mortar retail establishments are generally not as capable of leveraging information about individual shoppers as they physically enter stores to shop.

When a shopper enters a brick-and-mortar store, sales associates may engage the shopper in conversation in order to determine what the shopper might be interested in purchasing and when the shopper is looking to make the purchase. While the shopper might have a lot of information about the products available for sale, the sales associate generally does not have any information about the shopper's propensities, other than what the shopper might happen to mention. This lack of information about the shopper's propensities at the point of sale makes it difficult for the sales associates to efficiently and effectively direct their sales efforts.

Moreover, while online advertisements and other promotional campaigns can be targeted at individuals, brick-and-mortar retail establishments are usually limited to broadly targeted ad campaigns.

### SUMMARY

A method for estimating a probability of purchase within one or more windows of time for a subject includes accessing a dataset including financial transactions of a plurality of people over a predetermined period of time. Values are determined for each of a plurality of variables, for each of the plurality of people based on the dataset. An average time between purchases of a particular category is determined based on the dataset. The determined average time between purchases of the particular category is correlated with the determined values for each of the plurality of variables. A table or function is produced for estimating probabilities of purchase within one or more windows of time of the particular category based on the correlation. A subject is identified. Values are determined for each of the plurality of variables, for the identified subject, based on the dataset. The produced table or function and the determined values for the identified subject are used to estimate a probability of purchase within one or more windows of time for the particular category for the identified subject.

A system for displaying an estimated probability of purchase within one or more windows of time to a user includes an analytical server for accessing financial transactions for a plurality of people over a predetermined period of time and using the accessed financial transactions to determine a relationship between a plurality of variables and an average time between purchases of a particular type. An identification sensor receives identifying information. An identification server receives the identifying information and identifies a subject therefrom. An estimation server receives the relationship determined by the analytical server and applies the relationship to estimate probabilities of purchase within one or more windows of time for the identified subject.

A method for estimating a probability of purchase within one or more windows of time for a subject using survival analysis includes selecting one or more survival analysis variables. A relationship between the selected survival analysis variables and an average time between purchases for a particular category is established using a dataset including financial transactions of a plurality of people over a predetermined period of time. Values are determined for the selected survival analysis variables for a particular subject. Survival analysis is performed to estimate probabilities of purchase within one or more windows of time for the subject based on the determined values and the established relationship.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is a schematic diagram illustrating a system for providing an estimated likelihood that a shopper will make a particular purchase on a particular day, in accordance with exemplary embodiments of the present invention;

FIG. 2 is a flowchart illustrating an approach for generating the table/function that correlates survival analysis variables to time-to-next purchase in accordance with exemplary embodiments of the present invention;

FIG. 3 is a flowchart illustrating an approach for estimating a likelihood that a shopper will make a particular purchase on a particular day in accordance with exemplary embodiments of the present invention;

FIG. 4 is a diagram illustrating a display of a mobile device for providing estimated likelihood of purchase information in accordance with an exemplary embodiment of the present invention;

FIG. 5 is a schematic diagram illustrating a mobile device for providing estimated time likelihood of purchase information in accordance with an exemplary embodiment of the present invention; and

FIG. 6 shows an example of a computer system capable of implementing the method and apparatus according to exemplary embodiments of the present disclosure.

### DETAILED DESCRIPTION OF THE DRAWINGS

In describing exemplary embodiments of the present disclosure illustrated in the drawings, specific terminology is employed for sake of clarity. However, the present disclosure is not intended to be limited to the specific terminology so selected, and it is to be understood that each specific element includes all technical equivalents which operate in a similar manner.

Exemplary embodiments of the present invention relate to a system and method for providing sales associates within brick-and-mortar retail establishments with real-time information related to an estimate of a likelihood that an identified shopper will make a purchase for a product being shopped for at the retail establishment on a given day. However, exemplary embodiments of the present invention might be used, more broadly, as a system and method for estimating a period of time before an identified person is likely to make a purchase of a particular type.

The claimed approach may utilize an adapted version of survival analysis in producing this estimation. In survival analysis, generally, a period of time is estimated for the expected remaining life of a person or organism, based on one or more variables. For example, for the purpose of determining a remaining life expectancy of a person, the variables in question may be age, gender, status as a smoker/non-smoker, etc. A table may be prepared in which these variables are matched with an estimated remaining life expectancy so that the estimated remaining life expectancy for any person can be easily looked up. The table may be populated, in advance, by analyzing a set of data pertaining to a large group of individuals over a period of time. The survival rates of the people of the data may be correlated by the selected variables and the result may be used to populate the table.

There need not be an actual table used; the estimation of remaining life left may be algorithmically defined based on the analyzed data and then a formula may be used to calculate remaining life expectancy based on the variables.

Using survival analysis to estimate period of time before an identified person is likely to make a purchase of a particular type has an advantage of reducing computational cost associated with making such a prediction, reducing the amount of training data that is needed to make such a prediction, and reducing an amount of time over which data need be collected before making such a prediction.

According to exemplary embodiments of the present invention, the data being analyzed may be a consumer's transaction data over a predetermined period of time, and the result of the estimation may be a likelihood that the particular consumer makes a purchase of a particular type on a given day. Accordingly, exemplary embodiments of the present invention may adapt the algorithmic approaches to performing survival analysis to the question of how likely a particular customer may be to consummate a purchase of a particular type on a given day, such as the day the analysis is performed.

As discussed above, the survival analysis variables are those characteristics that are used to group subjects by type and to draw comparisons between subjects of a common type. Exemplary embodiments of the present invention may use as survival analysis variables, the following: (1) difference gap: the difference gap is a difference between the time the last purchase of a particular type was made and an average length of time between such purchases, (2) numnber of MCCs: the number of MCCs is the number of different merchant category codes (MCC) that a person transacted with within a particular length of time being looked at (“the review period”), (3) number of participant IDs: the number of unique merchants that a person transacted within the review period, (4) last purchase: the length of time that has passed since the last transaction made by the particular person, and (5) average amount: the average transaction value within the review period. However, as is described in greater detail below, other and/or different variables may be used to correlate time to next purchase.

Exemplary embodiments of the present invention may derive this data from electronic transaction data and various other sources.

Moreover, exemplary embodiments of the present invention may provide a mobile device that is used to identify a shopper and return the estimated likelihood of purchase for the particular day.

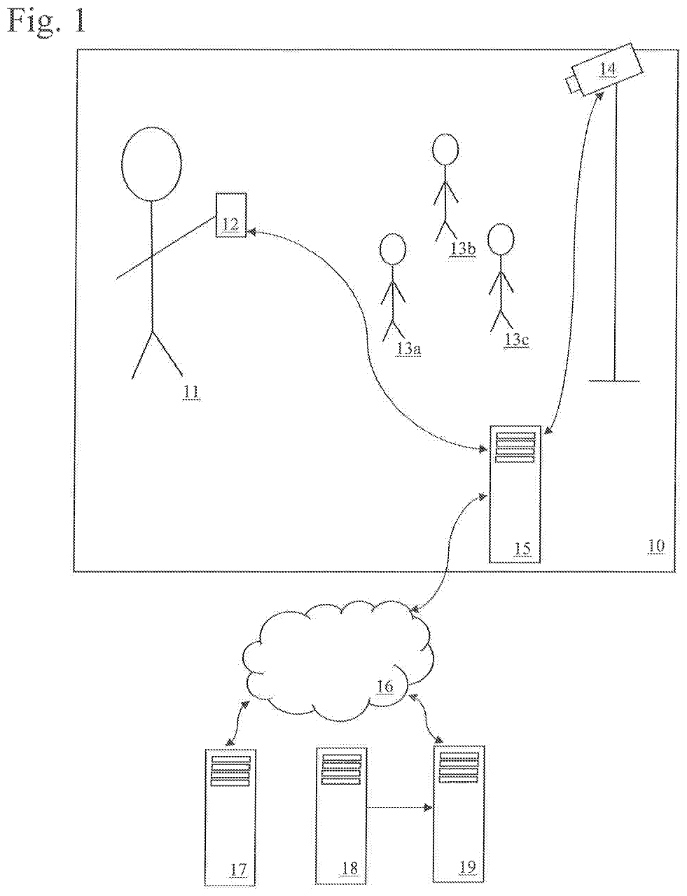

FIG. 1 is a schematic diagram illustrating a system for estimating a likelihood that a shopper will make a particular purchase on a particular day, in accordance with exemplary embodiments of the present invention. The system may be utilized within a facility 10 such as a retail establishment (e.g. a store), however, this arrangement is provided as an example, and exemplary embodiments of the present invention need not be limited to use within a store or any particular physical space. The retail establishment 10 may be outfitted with one or more identifying devices. The identifying device is configured to establish the identify of shoppers 13 (e.g. 13a, 13b, and 13c) within the retail establishment 10. The identifying device might be a credit card terminal, a near field communication (NFC) reader, a facial recognition system, etc. According to one exemplary embodiment of the present invention, each shopper may carry a store loyalty card with an integrated NFC chip that is registered as the shopper enters the retail establishment 10. Alternatively, the identifying device may include one or more cameras 14 for acquiring images of the shoppers, and a computer system 15 for performing facial recognition to identify the shoppers 13.

Once the computer system 15 identifies the shoppers 13, the computer system 15 may request likelihood of purchase for each shopper for a particular day such as the present day. This information may then be transmitted to a mobile device 12 carried by one or more sales associates 11 so that each sales associate may be able to better determine who is in need of assistance, for example, under the belief that those shoppers with the a high likelihood of making a particular purchase on that day are most in need of assistance.

The computer system 15 may be located within the retail establishment 10, however, the computer system 15 need not perform shopper identification and the estimation of likelihood of purchase, as these functions might be computationally expensive and involve access to lengthy and sensitive information. Accordingly, the computer system 15, according to exemplary embodiments of the present invention, may call upon an identification server 17, over a computer network 16 such as the Internet. The identification server 17 may be sent identifying data such as images of the shopper or NFC codes, and the identification server 17 may return, to the computer 15, an identity of the shopper. For example, the identification server 17 may perform facial recognition.

The computer system 15 may also call upon an estimation server 19. The estimation server 19 may be sent the identity of the shopper. The estimation server 19 may be able to call upon transaction data that can be used to determine the survival analysis variables for that shopper. The estimation server 19 may then estimate the likelihood of purchase for the shopper for the particular day, for example, the present day, and provide that information back to the computer system 15. The estimation server 19 may utilize a prepared table and/or prepared function that accepts as input, the survival analysis variables of the shopper, as well as the particular day, and provides, as output, the estimated likelihood of purchase. The table/function may have been prepared in advance, for example, by an analytical server 18 that accesses transaction data for a large group of consumers and employs the modified survival analysis approach described herein to correlate likelihood of purchase with the chosen survival analysis variables.

The transaction data may include transaction data for credit cards and other electronic payment means such as debit cards, smartphone payment systems, and the like. This transaction data may be provided by a service provider and the service provider may be or may receive this information from credit card processors and other parties involved in the processing of electronic transactions. These transactions may include, not only purchases, but returns, cash withdrawals, and the like.

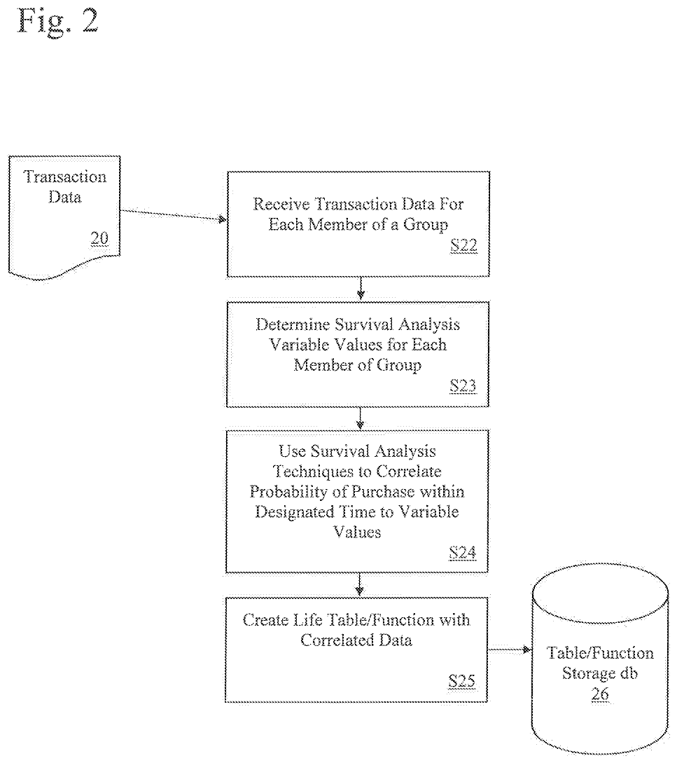

As discussed above, the table/function that correlates survival analysis variables to time-to-next purchase may be generated by the analytical server 18 while the estimation server 19 applies the generated table/function to the particular individual shopper and particular day. FIG. 2 is a flowchart illustrating an algorithm for generating the table/function that correlates survival analysis variables to likelihood of purchase in accordance with exemplary embodiments of the present invention. This approach may include the steps, as shown in FIG. 2, including receiving transaction data 20 for a group of individuals over a set period of time (Step S22). The transaction data 20 may include, for example, electronic payment card transactions such as credit card/debit card transactions. However, the transaction data 20 may additionally, or alternatively include other forms of electronic payment transaction data.

This data may pertain to various individuals and the data may be anonymized to remove sensitive personal information. The transaction data may include such information as a unique identifier for the individual, the date the transaction occurred, the monetary value of the transaction, the participant ID uniquely identifying the merchant participating in the transaction, and the merchant category code (MCC) for the merchant participating in the transaction. However, additional data may also be included.

Next, the received transaction data may be analyzed to determine the survival analysis values for each individual member of the group (Step S23). As described above, exemplary embodiments of the present invention may utilize any desired survival analysis values, and the values being used may depend on the nature of the goods and services being looked at, for example, those goods and services offered by the retail establishment, or other venture, using this approach. However, for the purposes of providing a thorough disclosure, in addition to the five survival analysis values described above, other survival analysis values may include: (6) average gap: the average length of time between each pair of proximate transactions for the particular person, within the particular block of time being analyzed (e.g. 91 days). This value may be null where there is only one transaction described, (7) total transactions: the total number of transactions attributable to the particular person within the block of time, (8) total amount: the total amount spent over all transactions within the block of time, (9) last amount: the monetary value of the most recent transaction, and (10) difference amount: the difference between the last amount and the average amount.

The survival analysis variable may also include various series variables. These series variables are defined with respect to the particular merchant, or particular MCC of the merchant, making use of the approach described herein (e.g., the retail establishment) and may represent a percentage of the overall group of people that make use of the particular merchant or its MCC. These series variables may be binary, for example, “1” might represent that a particular person has shopped at the merchant or its particular MMC within the predetermined period of time (e.g. the last 91 days), while “0” might represent that the particular person has not shopped at the merchant or its particular MMC within the predetermined period of time. However, rather than being binary, there may be 3 or more possible choices such as with different values representing whether the particular person has shopped at the merchant or its particular MMC within different periods of time. For example, 0 may represent that no purchase has been made for the merchant/MMC within the last 91 days, 1 may represent such a purchase has been made within the last 61 days, 2 may represent such a purchase has been made within the last 31 days, 3 may represent such a purchase has been made within the last 8 days, etc. Accordingly, some series variables look to the particular merchant (e.g. a single participant ID), while other series variables look to the MCC of the particular merchant.

Any combination of the above survival analysis variables may be used, and indeed other variables not mentioned herein may be used instead of or in addition to any of the aforementioned.

However, at step S23, the predetermined set of survival analysis variables are determined for each member of the group, within the predetermined period (e.g. 91 days).

Then, one or more survival analysis techniques may be used to determine a correspondence between the chosen survival analysis variables and a length of time between relevant purchases (Step S24). Here “relevant purchases” may be defined as transactions within the particular merchant, or it may be defined as transactions with the MCC of the particular merchant. According to some exemplary embodiments of the present invention, “relevant purchases” may be defined as some grouping of merchants that are not necessarily of a single MCC. These groupings can be defined in accordance to any desired criteria.

The performance of the survival analysis may be handled by algorithms developed and used for survival analysis and may be modified for this particular purpose. These algorithms may be instantiated as software executed on a computer system, such as the analytical server 18 described above. This software may also be made available as part of a cloud-based service.

The performance of survival analysis may be based on regression analysis of survival data based on various models such as the Cox proportional hazards model. According to this approach, the hazard ratio may be the probability the purchase behavior will happen in time t given that it not happened before. The survival time of each member of a population may be assumed to follow its own hazard function, λₜ(t), which may be expressed as:

λₜ(t)=λ(t;Zᵢ)=λ₀(t)exp(Z′ᵢβ)

where λ₀(t) is an arbitrary and unspecified baseline hazard function, Zᵢ is the vector of explanatory variables for the i-th individual, and β is the vector of unknown regression parameters associated with the explanatory variables. The vector β is assumed to be the same for all individuals. The survivor function can be expressed as:

S(t;Zᵢ)=[Sₒ(t)]^{exp(Z′}^{ᵢ}^{β)}

where S₀(i)=exp(−∫ₒ^{t}λₒ(u)(du) is the baseline survivor function. In this way, β of the Cox partial likelihood function may be estimated to eliminate the unknown baseline hazard λₒ(t) and accounts for censored survival times.

While the survival rate may be calculated as provided above, exemplary embodiments of the present invention may calculate a cumulative purchase rate, which may be calculated as 1−S(t;Z).

The partial likelihood of Cox may allow time-dependent explanatory variables. An explanatory variable may be time-dependent if its value for any given individual can change over time.

Models may also be fit with time-dependent explanatory variables using a counting process style of input. The counting process formulation enables the fitting of a superset of the Cox model, known as the multiplicative hazards model. This extension also includes recurrent events data and left truncation of failure times. For example, models such as the Andersen-Gill model may be used.

The population under study can consist of a number of subpopulations, each of which has its own baseline hazard function. A stratified analysis may be performed to adjust for subpopulation differences. Under the stratified model, the hazard function for the j-th individual in the i-th stratum may be expressed as:

λᵢⱼ(t)=λᵢ₀(t)exp(Z′ᵢⱼβ)

where λᵢ₀(t) is the baseline hazard function for the i-th stratum, and Z^{ij} is the vector of explanatory variables for the individual. The regression coefficients may be assumed to be the same for all individuals across all strata.

Ties in the failure times can arise when the time scale is genuinely discrete or when survival times generated from the continuous-time model are grouped into coarser units. There may be various methods for handling ties.

A discrete logistic model may be available for discrete time-scale data. Other methods may be applied to continuous time-scale data. An exact method computes the exact conditional probability under the model that the set of observed tied event times occurs before all the censored times with the same value or before larger values. Other methods, such as the Breslow method and the Efron method may provide approximations to the exact method.

There may be many ways for selecting a best set of survival analysis variables. Multiple regression may be used to determine which subset of the survival analysis variables may be most effective for a particular use. According to one approach, subset selection is based on a likelihood score statistic. This method identifies a specified number of best models containing one, two, or three variables and so on, up to the single model containing all of the explanatory variables. The most effective set is determined based on the results of having tried the approach each way.

The output of having used survival analysis in this way may be in the form of a table, particularly where the number of survival analysis variables is relatively low (e.g. two or three survival analysis variables are used). However, more realistically, the output would be a function that takes as inputs, values for each selected survival analysis variable (and perhaps the present date), and provides, as output, the estimated probability that the next relevant purchase will be made within one or more particular time periods (Step 25). The table/function may be stored in a database 26 where it may be retrieved, for example, by the estimation server 19.

The process of correlating probability of purchase with the selected survival analysis variables and estimating the probability of purchase for a particular customer therefrom may be performed iteratively, as the estimating of the probability of purchase for each customer may be used to better perform the correlation. This may be especially significant where estimating the probability of purchase is performed systematically for all prospective customers within a particular list, as will be described in greater detail below. Accordingly, the number of iterations to be performed may be set to achieve a satisfactory tradeoff between run time and model lift across all categories.

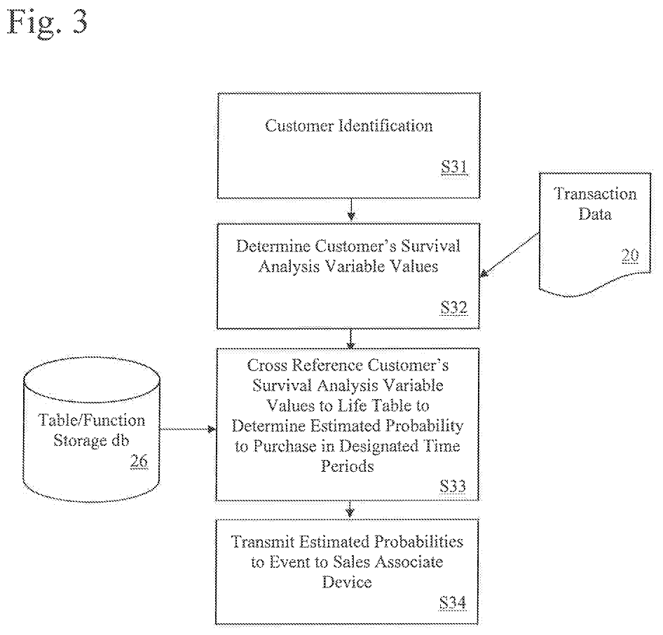

FIG. 3 is a flowchart illustrating an algorithm for estimating probability of purchase within one or more particular time periods in accordance with exemplary embodiments of the present invention. The algorithm includes the steps shown in FIG. 3, including, the particular customer may be identified (Step S31). Identifying the customer may be performed using an automatic approach such as by RFID or facial recognition, as described above, or may be manually performed by asking the customer for their name or other identifying information.

The customer need not be physically present in order to be identified. According to some exemplary embodiments of the present invention, the customer may be systematically selected from a list of prospective customers, for example, when it is desired that the list of prospective customers be reviewed to create a subset of prospective customers who are likely to make a relevant purchase within a near future (e.g. within the next 2 weeks).

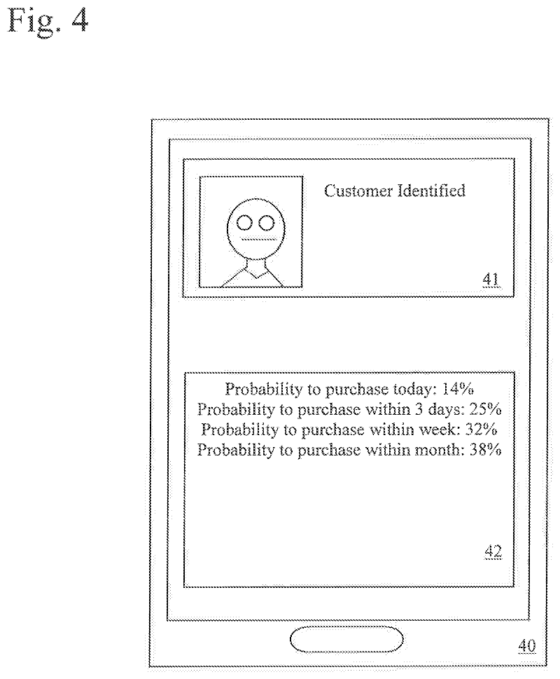

Values for the customer's survival analysis variables identified customer may then be determined (Step S32). This may be performed, for example, by referencing the transaction data 20. Then, the table/function may be retrieved from the database 26 and used to estimate the time-to-next-purchase (Step S33). This estimated time-to-next-purchase may then be used, for example, to add or remove the customer from the subset, as described above, or to transmit this value to a sales associate (Step S34).

Where this approach is used to generate a subset of customers with a relatively high probability of making a purchase within a predetermined period of time (such as 2 weeks), the table/function may be used to include or exclude each prospective customer of a list of prospective customers to the subset. Then, the subset of prospective customers may be targeted with an advertisement campaign or other promotional program.

Where this approach is used to assist a sales associate on a sales floor, a mobile device 40 of the sales associate, as can be seen in FIG. 4, may display the customer identification information 41 along with the estimated probabilities of purchasing within various periods of time 42 so that the sales associate may operate more efficiently. Here, FIG. 4 is a diagram illustrating a display of a mobile device for providing estimated probability of purchase information in accordance with an exemplary embodiment of the present invention.

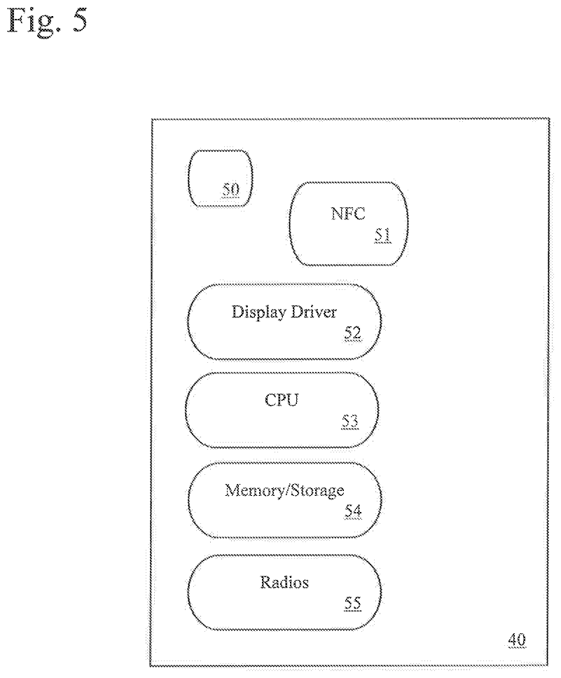

FIG. 5 is a schematic diagram illustrating a mobile device for providing estimated probability of purchase information in accordance with an exemplary embodiment of the present invention. The mobile device 40 may include a camera module 50 and/or NFC sensor 51 for identifying a customer. The mobile device 40 may also include a central processing unit (CPU) 52 for controlling overall operation of the mobile device 40, memory and storage space 53, communications radios for receiving the transmitted personal information and estimated probability of purchase, and a display driver 51 and display panel for displaying this information to the sales associate.

It is noted that the selection of the survival analysis variables may, to a large extent, determine the success rate of the present approach. Accordingly, some exemplary embodiments of the present invention may perform the aforementioned process multiple times, while changing the survival analysis variables each time (or adding additional survival analysis variables each time) so that an optimal selection may be automatically determined. The process may also be repeated for different category definitions, where the category definition determines which unique merchants are considered within the same group for the purposes of determining an estimated probability of purchase within that group.

Also, the review period block of time (mentioned above as 91 days) may be changed and the process repeated for various review periods in order to obtain an optimal review period for a particular use.

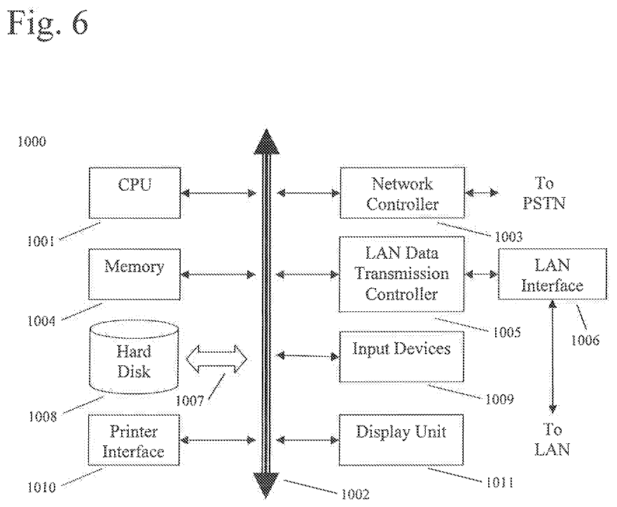

FIG. 6 shows an example of a computer system which may implement a method and system of the present disclosure, for example, as may embody the computer system 15, the identification server 17, analytical server 18, and the estimation server 19. The system and method of the present disclosure may be implemented in the form of a software application running on a computer system, for example, a mainframe, personal computer (PC), handheld computer, server, etc. The software application may be stored on a recording media locally accessible by the computer system and accessible via a hard wired or wireless connection to a network, for example, a local area network, or the Internet.

The computer system referred to generally as system 1000 may include, for example, a central processing unit (CPU) 1001, random access memory (RAM) 1004, a printer interface 1010, a display unit 1011, a local area network (LAN) data transmission controller 1005, a LAN interface 1006, a network controller 1003, an internal bus 1002, and one or more input devices 1009, for example, a keyboard, mouse etc. As shown, the system 1000 may be connected to a data storage device, for example, a hard disk, 1008 via a link 1007.

Exemplary embodiments described herein are illustrative, and many variations can be introduced without departing from the spirit of the disclosure or from the scope of the appended claims. For example, elements and/or features of different exemplary embodiments may be combined with each other and/or substituted for each other within the scope of this disclosure and appended claims.

What is claimed is:

1. A method for estimating a probability of purchase within one or more windows of time for a subject, comprising:
accessing a dataset including financial transactions of a plurality of people over a predetermined period of time;
determining values for each of a plurality of variables, for each of the plurality of people based on the dataset;
determining an average time between purchases of a particular category based on the dataset;
correlating the determined average time between purchases of the particular category with the determined values for each of the plurality of variables;
producing a table or function for estimating probabilities of purchase within one or more windows of time of the particular category based on the correlation;
identifying a subject;
determining values for each of the plurality of variables, for the identified subject, based on the dataset; and
using the produced table or function and the determined values for the identified subject to estimate a probability of purchase within one or more windows of time for the particular category for the identified subject.

2. The method of claim 1, wherein the estimated probability of purchase within the one or more windows of time for the subject is transmitted to a user console and displayed thereon.

3. The method of claim 1, wherein the plurality of variables includes:
a difference gap;
a number of merchant category codes;
a number of participant identifications;
a last purchase time; and
an average transaction amount.

4. The method of claim 3, wherein the plurality of variables further includes one or more of:
an average gap;
a number of total transactions;
a total amount transacted;
a last amount transacted; or
a difference amount.

5. The method of claim 1, wherein the dataset includes credit card transaction data.

6. The method of claim 1, wherein survival analysis is used to correlate the determined average time between purchases of the particular category with the determined values for each of the plurality of variables.

7. The method of claim 1, wherein the particular category is a merchant category code.

8. The method of claim 1, wherein the predetermined period of time is 91 days.

9. A system for displaying an estimated probability of purchase within one or more windows of time to a user, comprising:
an analytical server for accessing financial transactions for a plurality of people over a predetermined period of time and using the accessed financial transactions to determine a relationship between a plurality of variables and an average time between purchases of a particular type;
an identification sensor for receiving identifying information;
an identification server for receiving the identifying information and identifying a subject therefrom; and
an estimation server for receiving the relationship determined by the analytical server and applying the relationship to estimate probabilities of purchase within one or more windows of time for the identified subject.

10. The system of claim 9, further including a mobile device for receiving the estimated probabilities of purchase within the one or more windows of time from the estimation server and for displaying the received estimated time-to-purchase to a user.

11. The system of claim 9, wherein a computer system local to the identification sensor receives the identifying information and transmits the identifying information to the identification server over a computer network.

12. The system of claim 11, wherein the computer system receives the estimated probabilities of purchase within one or more windows of time information from the estimation server, over the computer network, and transmits the estimated probabilities of purchase within one or more windows of time information to the mobile device over a local wireless network.

13. The system of claim 9, wherein the identification sensor includes a camera module and the identification server is configured to perform facial recognition.

14. The system of claim 9, wherein the identification sensor is a near field communication (NFC) reader and the identification server is a database for matching NFC codes to individuals.

15. A method for estimating a probability of purchase within one or more windows of time for a subject using survival analysis, comprising:
selecting one or more survival analysis variables;
establishing a relationship between the selected survival analysis variables and an average time between purchases for a particular category using a dataset including financial transactions of a plurality of people over a predetermined period of time;
determining values for the selected survival analysis variables for a particular subject; and
performing survival analysis to estimate probabilities of purchase within one or more windows of time for the subject based on the determined values and the established relationship.

16. The method of claim 15, wherein the one or more survival analysis variables includes:
a difference gap;
a number of merchant category codes;
a number of participant identifications;
a last purchase time; and
an average transaction amount.

17. The method of claim 16, wherein the one or more survival analysis variables further includes one or more of:
an average gap;
a number of total transactions;
a total amount transacted;
a last amount transacted; or
a difference amount.

18. The method of claim 15, wherein the dataset includes credit card transaction data.

19. The method of claim 15, wherein the performance of the survival analysis correlates a determined average time between purchases of a particular category with values for each of the one or more survival analysis variables.

20. The method of claim 15, wherein the estimated time-to-purchase is transmitted to a mobile terminal where it is displayed to a user.
